(19) United States
(12) Patent Application Publication
(10) Pub. No.: US 2026/0093204 A1
(43) Pub. Date: Apr. 2, 2026

(54) IMAGE FORMING APPARATUS

(71) Applicant: CANON KABUSHIKI KAISHA, Tokyo (JP)

(72) Inventors: TAKASHI HONKE, Shizuoka (JP); HIROSHI KATAOKA, Shizuoka (JP); HIDEKI OHTA, Shizuoka (JP)

(21) Appl. No.: 19/335,857

(22) Filed: Sep. 22, 2025

(30) Foreign Application Priority Data
Sep. 27, 2024 (JP) 2024-169370

(51) Int. Cl. G03G 21/16; G03G 15/00; G03G 15/20

(52) U.S. Cl. CPC G03G 21/1647; G03G 15/2035; G03G 15/2064; G03G 15/6573; G03G 21/1638; G03G 2215/00417; G03G 2215/2025; G03G 2221/1639; G03G 2221/1654; G03G 2221/1675; G03G 2221/169

(57) ABSTRACT

An image forming apparatus includes an apparatus main body having an opening portion, an opening and closing member supported to open/close relative to the apparatus main body; a fixing unit detachably supported with respect to the apparatus main body via the opening portion, including a heating unit and a pressure roller forming a fixing nip and a pair of conveyance rotation members having a conveyance nip, including a urging portion for urging the fixing unit toward a second position from a first position. In a case where the sheet is jammed while being caught in the fixing nip and the conveyance nip, and in a case where urging force of the urging portion acts on the sheet, a tensile force acting on the sheet is less than a binding force of the fixing nip and the conveyance nip.

### BACKGROUND

### Field of the Technology

The present disclosure relates to an image forming apparatus which forms a toner image on a sheet.

### Description of the Related Art

Conventionally, there has been a proposed image forming apparatus which includes a pair of arm members pivotably provided on the apparatus main body and a fixing device held by end portions of the arm members (see Japanese Patent Laid-Open No. 2012-047806). By the pair of arm members being pivoted, the fixing device can be moved between an internal mounting position and a temporary holding position closer to an opening portion in the apparatus main body than the internal mounting position.

However, according to the image forming apparatus discussed in Japanese Patent Laid-Open No. 2012-047806, in a case where a sheet is jammed while being caught in a fixing nip of the fixing device and another pair of conveyance rollers, movement of the fixing device to the temporary holding position from the internal mounting position deforms the sheet significantly. In this case, it is difficult to perform jam clearance processing, so that the jam clearance capability is degraded.

### SUMMARY

The present disclosure is directed to an image forming apparatus capable of preventing degradation of jam clearance capability.

An aspect of the present disclosure provides an image forming apparatus that forms a toner image on a sheet, the image forming apparatus including an apparatus main body having an opening portion, an opening and closing member, a fixing unit, a pair of conveyance rotation members, and a moving unit. When in a closed position, the opening and closing member covers the opening portion. When in an opened position, the opening and closing member uncovers the opening portion. The fixing unit is detachable from and supported by the apparatus main body via the opening portion. The fixing unit includes a heating unit configured to heat the toner image formed on the sheet and a pressure roller, with a fixing nip for nipping the sheet formed by the pressure roller and the heating unit. The pair of conveyance rotation members are configured to form a conveyance nip for nipping and conveying the sheet, with the pair of conveyance rotation members being arranged to convey the sheet with the fixing nip. The pair of conveyance rotation members is being arranged on the apparatus main body downstream of the fixing unit in a sheet conveyance direction. The moving unit is arranged on the apparatus main body, with the moving unit being configured to move the fixing unit from a first position to a second position, and with the moving unit including an urging portion configured to provide a force urging the fixing unit toward the second position from the first position. With the opening and closing member in the closed position, movement of the fixing unit from the first position to the second position is restricted. With the opening and closing member in the opened position, movement of the fixing unit by the moving unit is allowed.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional diagram illustrating an image forming apparatus according to a first embodiment.

FIG. 2 is a cross-sectional diagram illustrating the image forming apparatus in a state where a door is opened.

FIG. 3 is a cross-sectional diagram illustrating the image forming apparatus in a state where a fixing device is moved up to a second position.

FIG. 4 is a cross-sectional diagram illustrating the image forming apparatus in a state where a transfer unit and a tray unit are pulled out of an opening portion.

FIG. 5A is a perspective diagram illustrating the image forming apparatus in the state where the door is opened. FIG. 5B is a perspective diagram illustrating the fixing device at the second position. FIG. 5C is a perspective diagram illustrating a state where the fixing device is detached from a moving unit. FIG. 5D is a perspective diagram illustrating the image forming apparatus in a state where a cover is opened.

FIG. 6A is a cross-sectional diagram illustrating a state where a sheet is jammed while being caught in a fixing nip and a discharge nip. FIG. 6B is a cross-sectional diagram illustrating a state where the fixing device is moved to the second position in the state illustrated in FIG. 6A.

FIG. 7 is a cross-sectional diagram illustrating forces acting on the sheet.

FIG. 8A is a cross-sectional diagram illustrating the fixing device at a first position. FIG. 8B is a cross-sectional diagram illustrating a case where the fixing device is moved to the second position. FIG. 8C is a cross-sectional diagram illustrating a state where upward movement of the fixing device is restricted.

FIG. 9A is a cross-sectional diagram illustrating a fixing device according to a second embodiment. FIG. 9B is a cross-sectional diagram illustrating a state where a sheet is jammed while being caught in a fixing nip and a discharge nip.

FIG. 10 is a cross-sectional diagram illustrating a state where an end portion of a division member is in contact with the sheet.

FIG. 11 is a cross-sectional diagram illustrating forces acting on the sheet.

### DESCRIPTION OF THE EMBODIMENTS

### First Embodiment

### [General Configuration]

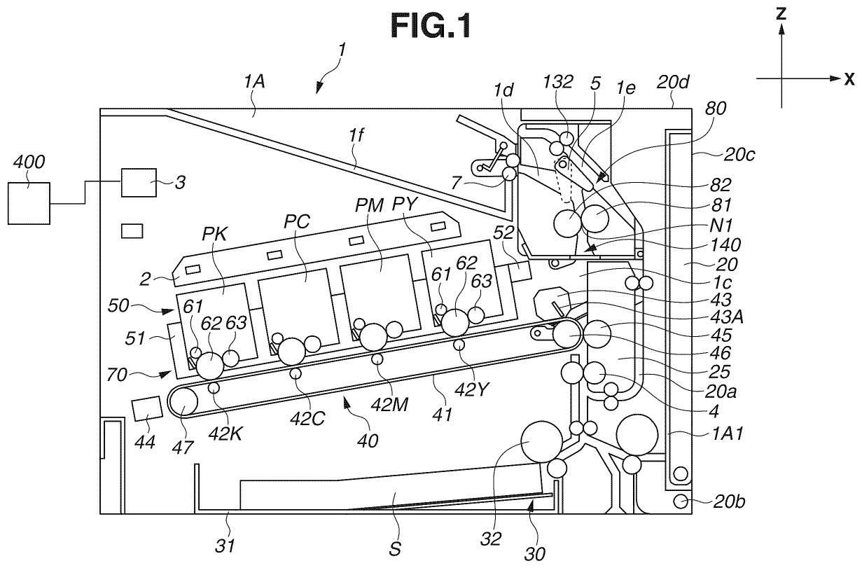

An image forming apparatus 1 according to a first embodiment is an electrophotographic full-color laser beam printer. FIG. 1 is a cross-sectional diagram illustrating the image forming apparatus 1.

Examples of the image forming apparatus include a printer, a copying machine, a facsimile, and a multifunction peripheral. Thus, the image forming apparatus refers to an apparatus which forms an image on a sheet used as a recording medium based on image information received from an external personal computer (PC) or image information read from a document. While additional devices, such as an optional feeder, an image reading device, and a sheet processing device may be joined to the image forming apparatus in addition to the main body having an image forming function, the entire system provided with those additional devices joined is also regarded as a type of image forming apparatus. Further, examples of the sheet include paper, such as a sheet of paper and an envelope, a plastic film, such as an overhead projector (OHP) sheet, and fabric.

As illustrated in FIG. 1, the image forming apparatus 1 includes an apparatus main body 1A having an opening portion 1A1 and a door 20 serving as an opening and closing member. The door 20 is supported to be openable and closable relative to the apparatus main body between a closed position where the door 20 covers the opening portion 1A1 and an opened position where the opening portion 1A1 is uncovered. The door 20 is configured to be pivotable about a pivot shaft 20b.

The apparatus main body 1A accommodates an image forming unit 70 for forming an image on a sheet, a feeding unit 30, a fixing device (a fixing unit) 80, a pair of discharge rollers 7, and a moving unit 140 described below. The image forming unit 70 includes a transfer unit 40, a tray unit 50 disposed above the transfer unit 40, and a scanner 2 disposed above the tray unit 50.

The tray unit 50 includes a tray 51 capable of being pulled out of the apparatus main body 1A and four process cartridges PY, PM, PC, and PK which respectively form toner images in four colors, yellow (Y), magenta (M), cyan (C), and black (K). The four process cartridges PY, PM, PC, and PK are placed in the tray 51. The tray 51 includes a tray handle 52 which the user can grasp.

Configurations of the four process cartridges PY, PM, PC, and PK are the same as each other, except that images are formed in different colors. Thus, the configuration of the process cartridge PY and image forming processing performed by the process cartridge PY alone will be described, and descriptions of the process cartridges PM, PC, and PK will be incorporated by reference for conciseness.

The process cartridge PY includes a photosensitive drum 62, a charging roller 61, and a development roller 63. The photosensitive drum 62 is configured with an organic photoconductive layer applied to the outer surface of an aluminum cylinder, and is rotated by a drive motor. The directions of the respective rotation axis lines of the photosensitive drum 62, the development roller 63, and the charging roller 61 are parallel to each other.

The transfer unit 40 includes a drive roller 46, a tension roller 47, and an intermediate transfer belt 41 wound around the drive roller 46 and the tension roller 47. Primary transfer rollers 42Y, 42M, 42C, and 42K are arranged inside the intermediate transfer belt 41. A secondary transfer roller 45 is disposed to face the drive roller 46 with the intermediate transfer belt 41 in between, and the intermediate transfer belt 41 and the secondary transfer roller 45 forms a transfer nip where an image is transferred to a conveyed sheet S. Further, an optical sensor 44 for detecting a toner image transferred to the intermediate transfer belt 41 is disposed on the image forming unit 70.

The rotation axis of each of the primary transfer rollers 42Y, 42M, 42C, and 42K, the drive roller 46, the tension roller 47, and the secondary transfer roller 45 are each parallel to each other.

The feeding unit 30 is arranged on the lower part of the image forming apparatus 1, and includes a cassette 31 for stacking sheets S, and a pick-up roller 32 for feeding the sheets S supported by the cassette 31. The cassette 31 is configured to be attachable and detachable with respect to the apparatus main body 1A on the same side as the opening portion 1A1. A discharge tray 1f is arranged on the upper part of the apparatus main body 1A, so that the sheets S discharged by the pair of discharge rollers 7 serving as a pair of discharge rotation members are stacked on the discharge tray 1f.

The fixing device 80 includes a pressure roller 81, a heating roller 82, a guiding member 5, and a pair of reversing rollers 132. The heating roller 82 includes a built-in heater, and the pressure roller 81 is in contact with the heating roller 82 with predetermined pressure. The heating roller 82 and the pressure roller 81 form a fixing nip N1 for nipping the sheet S and fixing a toner image to the sheet S by applying heat and pressure to the sheet S. The guiding member 5 is configured to be pivotable between a discharge position for guiding the sheet S to a discharge path 1d and a reversing position for guiding the sheet S to a reversing path 1e.

An image forming operation of the image forming apparatus 1, configured as described above, will now be described. The image forming apparatus 1 includes a control unit 3 connected to an external host device 400. Based on an image signal received from the external host device 400 or a reading unit, the control unit 3 controls the scanner 2 to emit a laser beam corresponding to the image signal to the photosensitive drum 62 of the process cartridge PY. The external host device 400 is, for example, a personal computer, an image reader, or a facsimile.

At this time, the surface of the photosensitive drum 62 is uniformly charged by the charging roller 61 with a predetermined polarity and an advance potential, and an electrostatic latent image is formed on the surface by the laser beam emitting from the scanner 2. The electrostatic latent image formed on the photosensitive drum 62 is developed by the development roller 63, so that a Y toner image is formed on the photosensitive drum 62.

The development roller 63 is configured to be in contact with or to be separated from the photosensitive drum 62. When the image forming apparatus 1 does not perform the image forming operation, the development roller 63 is separated from the photosensitive drum 62, to extend the service life of the photosensitive drum 62 and the development roller 63.

Similarly, the scanner 2 emits laser beams to the photosensitive drums of the process cartridges PM, PC, and PK, so that toner images of the respective colors, i.e., M, C, and K, are formed on the photosensitive drums, respectively. The toner images of the respective colors formed on the photosensitive drums are transferred to the intermediate transfer belt 41 by the primary transfer rollers 42Y, 42M, 42C, and 42K, and conveyed to the transfer nip by the intermediate transfer belt 41 rotated by the drive roller 46. The processing of forming images in the respective colors is timed so that each of the respective images is superimposed on the upstream toner image primarily transferred to the intermediate transfer belt 41. Further, residual toner remaining on the photosensitive drum 62 is removed with a cleaning blade 43A.

In parallel with this image forming processing, a sheet S accommodated in the cassette 31 of the feeding unit 30 is fed to a conveyance path 1c by the pick-up roller 32. Skew of the sheet S is corrected by a pair of registration rollers 4 arranged on the conveyance path 1c, and the sheet S is conveyed at predetermined conveyance timing, adjusted to timing for transferring the image at the transfer nip.

Then, a full-color toner image formed on the intermediate transfer belt 41 is transferred to the sheet S at the transfer nip by a secondary transfer bias applied to the secondary transfer roller 45. Further, residual toner remaining on the intermediate transfer belt 41 is removed with the cleaning blade 43A disposed in a cleaning unit 43. The heating roller 82 and the pressure roller 81 included in the fixing device 80 apply predetermined heat and pressure to the sheet S on which the toner image is transferred, so that the toner is melted and adhered (fixed) to the sheet S. The sheet S that has passed through the fixing device 80 is guided to the discharge path 1d or the reversing path 1e by the guiding member 5.

When a single-sided print job for printing an image on only one side of the sheet S is input to the image forming apparatus 1, the guiding member 5 is positioned at the discharge position, and the sheet S is guided to the discharge path 1d. The sheet S guided to the discharge path 1d is discharged to the outside of the apparatus by the pair of discharge rollers 7, and stacked on the discharge tray 1f.

When a double-sided print job for printing images on both sides of the sheet S is input to the image forming apparatus 1, the sheet S is guided to the reversing path 1e by the guiding member 5 at the reversing position after the image is formed on a first side of the sheet S at the transfer nip. After the trailing end of the sheet S passes through the guiding member 5, the pair of reversing rollers 132 disposed on the reversing path 1e changes the conveyance direction to convey the sheet S in the reverse direction. At this time, the guiding member 5 is moved to the discharge position, so that the sheet S conveyed in the reverse direction is guided to a two-sided conveyance path 20a by the guiding member 5.

The sheet S guided to the two-sided conveyance path 20a is conveyed to the conveyance path 1c by a plurality of pairs of conveyance rollers, and an image is formed on a second side of the sheet S at the transfer nip. Then, as described above, after the fixing device 80 fixes the toner image to the sheet S, the sheet S is discharged to the discharge tray 1f by the pair of discharge rollers 7.

### [Schematic Configuration of Moving Unit]

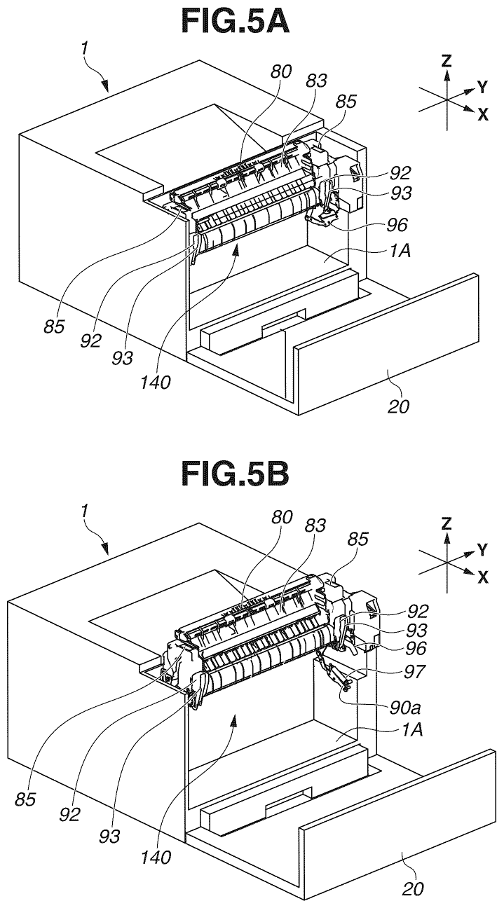

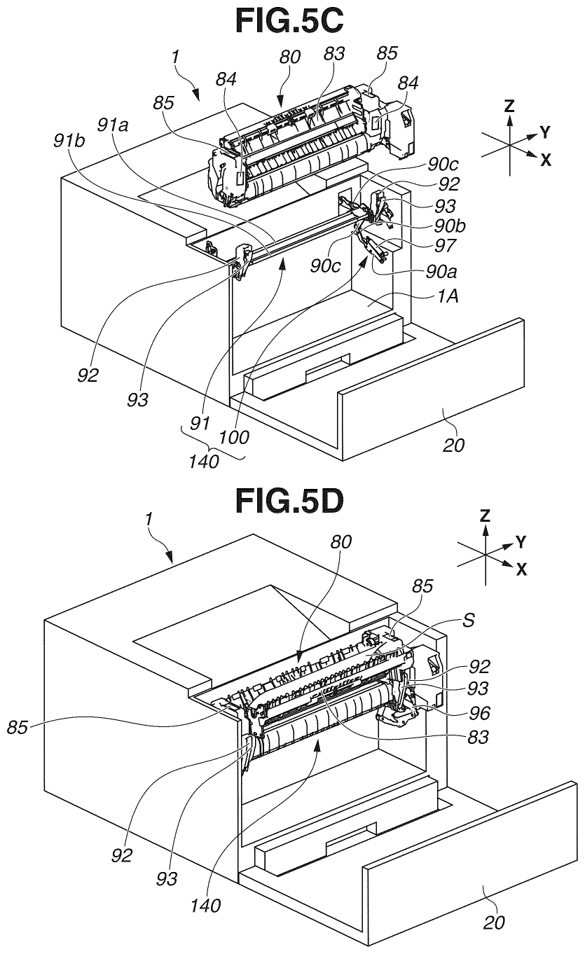

A schematic configuration of the moving unit 140 will now be described with reference to FIG. 5C. FIG. 5C is a perspective diagram illustrating a state where the fixing device 80 is detached from the moving unit 140.

The moving unit 140 is arranged between a right plate and a left plate constituting a part of the apparatus main body 1A. As illustrated in FIG. 5C, the moving unit 140 includes a supporting portion 91 and a lifting portion 100.

In the following descriptions and drawings, when the image forming apparatus 1 is placed on a horizontal plane, a vertical direction is referred to as a Z axis direction, with the vertical direction also referred to as the upward direction. The direction of the rotation axis line of the photosensitive drum 62 included in the image forming apparatus 1 is referred to as a Y axis direction. The direction intersecting with both the Z axis direction and the Y axis direction is referred to as an X axis direction. The X axis direction, the Y axis direction, and the Z axis direction can be orthogonal to each other. In other words, the X axis direction and the Y axis direction are horizontal directions. Further, one side of the X axis directions (a side indicated by an arrow X in FIGS. 1-5D) may be referred to as an X direction, and the other side of the X axis directions as a-X direction. Similarly, one side of the Y axis directions (a side indicated by an arrow Y) may be referred to as a Y direction, and the other side of the Y axis directions as a-Y direction. One side of the Z axis directions (a side indicated by an arrow Z) may be referred to as a Z direction, and the other side of the Z axis directions as a-Z direction.

The X direction may be referred to as the front face side (the front side) of the image forming apparatus 1, which corresponds to the side where the door 20 is opened. Further, with the front view of the image forming apparatus 1 as a reference, the Y direction may be referred to as the right side, and the −Y direction side as the left side.

The lifting portion 100 includes an arm unit disposed on one side in the Y direction parallel to the lengthwise direction of the fixing device 80, and an arm unit disposed on the other side in the Y direction of the fixing device 80. These two arm units have similar configurations, so that the arm unit disposed on one side (the right side) alone of the fixing device 80 in the Y direction will now be described.

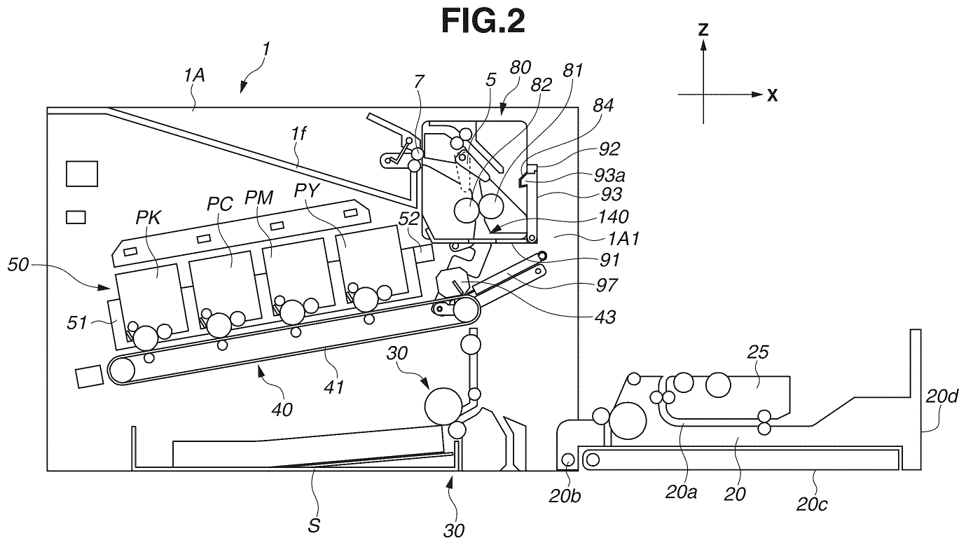

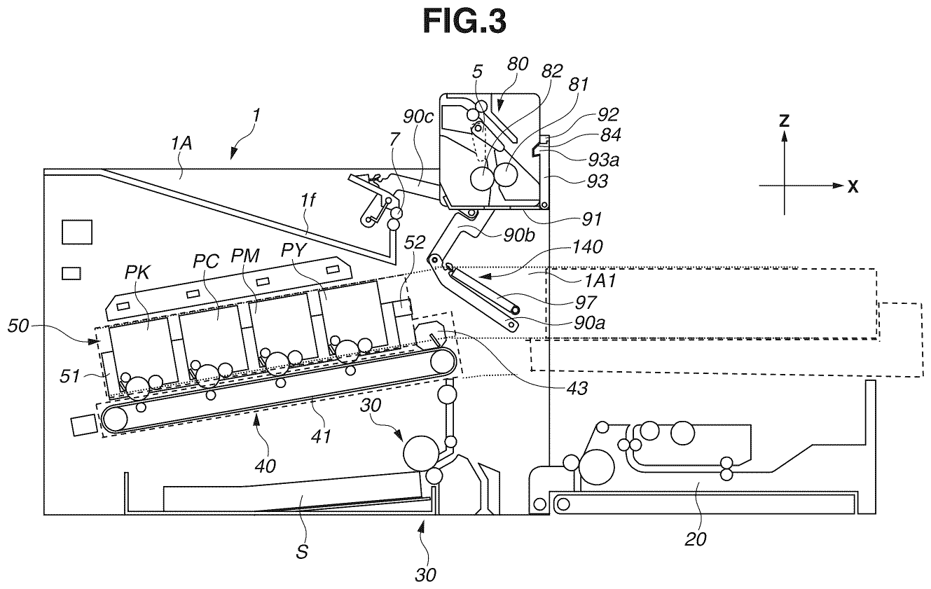

As illustrated in FIGS. 2 and 3, the arm unit includes arms 90a, 90b, and 90c, and an urging member 97 serving as an urging portion for urging the arms 90a, 90b, and 90c.

The arms 90a, 90b, and 90c constitute a link mechanism. In the present embodiment, the urging member 97 includes a coil spring. However, the configuration is not limited thereto. For example, the urging member 97 may include another spring, such as a flat spring, or may include a plurality of types of springs.

The supporting portion 91 includes a metallic frame 91a and a shaft member 91b extending in the Y direction (FIG. 5D). The metallic frame 91a is formed substantially in a U-shape in a planar view. The metallic frame 91a is joined to the shaft member 91b, so that the entire supporting portion 91 is formed in a rectangular shape. With this configuration, it is possible to improve the rigidity of the supporting portion 91. The supporting portion 91 is joined to the lifting portion 100 and is moved up and down together with the lifting portion 100. The supporting portion 91 supports the bottom surface of the fixing device 80.

In other words, the supporting portion 91 supports the fixing device 80 in a detachable manner from below.

In a state where the door 20 is positioned at the closed position as illustrated in FIG. 1, the fixing device 80 is accommodated within the image forming apparatus 1 and positioned at the first position where the fixing device 80 can fix a toner image to the sheet S in the image forming operation. In a state where the fixing device 80 is supported by the supporting portion 91, the moving unit 140 can move the fixing device 80 to the second position, as illustrated in FIG. 3. Hereinafter, a position of the moving unit 140 when the door 20 is positioned at the closed position is a storage position, and a position of the moving unit 140 capable of supporting the fixing device 80 at the second position is a supporting position. In other words, the moving unit 140 is configured to be ascendable from the storage position (i.e., the position illustrated in FIG. 1) to the supporting position (i.e., the position illustrated in FIG. 3) by an urging force of the urging member 97.

### [Movement of Transfer Unit and Tray Unit]

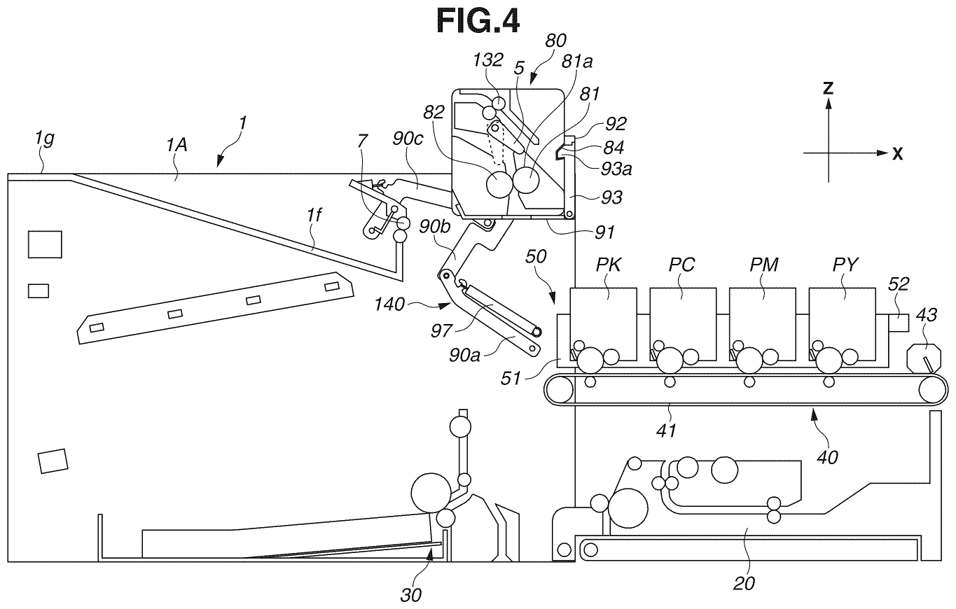

The movement of the transfer unit 40 and the tray unit 50 will now be described with reference to FIGS. 2 to 4. FIG. 2 is a cross-sectional diagram illustrating the image forming apparatus 1 in a state where the door 20 is opened. FIG. 3 is a cross-sectional diagram illustrating the image forming apparatus 1 in a state where the fixing device 80 is moved up to the second position. FIG. 4 is a cross-sectional diagram illustrating the image forming apparatus 1 in a state where the transfer unit 40 and the tray unit 50 are pulled out of the opening portion 1A1.

As illustrated in FIG. 2, when the door 20 is opened, the opening portion 1A1 of the apparatus main body 1A is uncovered. When the door 20 is moved to the opened position, the fixing device 80 is exposed to the outside of the image forming apparatus 1 via the opening portion 1A1. As illustrated in FIGS. 1 and 2, the door 20 includes a side surface 20c which constitutes one side surface of a plurality of side surfaces of the image forming apparatus 1, and a top surface 20d which constitutes a part of the top surface of the image forming apparatus 1, and the entire door 20 is formed in a substantially L-shape. Thus, when the door 20 is moved to the opened position, the space above the fixing device 80 is exposed, which has been covered by the top surface 20d of the door 20 in the closed position, thereby allowing the fixing device 80 to be moved up from the first position to the second position. In other words, movement of the fixing device 80 in the upward direction (upward movement) from the first position to the second position is restricted in a state where the door 20 is at the closed position, and the upward movement is allowed in a state where the door 20 is at the opened position. In the present embodiment, as illustrated in FIGS. 1 and 2, the fixing device 80 at the first position does not overlap with the door 20 at the closed position when viewed in the Y direction, and the fixing device 80 at the second position at least partially overlaps with the door 20 at the opened position when viewed in the Y direction.

When the door 20 is moved to the opened position from the closed position, the opening portion 1A1 is uncovered, so that the conveyance path 1c and the two-sided conveyance path 20a are exposed. With this configuration, the sheet S that may be jammed at the conveyance path 1c or at the two-sided conveyance path 20a can be removed. The door 20 pivotably supports a secondary transfer frame 25 for supporting the secondary transfer roller 45. The two-sided conveyance path 20a can widely be opened by the secondary transfer frame 25 being pivoted in a state where the door 20 is at the opened position. Hereinafter, a state where the sheet S is stuck and stops in the conveyance path is referred to as a jam, and an operation performed to clear the jam is referred to as jam clearance processing.

Then, as illustrated in FIG. 3, by the moving unit 140 moving up to the supporting position from the storage position, the fixing device 80 moves to the second position, and the space below the fixing device 80 is exposed. Thus, the transfer unit 40 and the tray unit 50 serving as an image forming unit for forming toner images on the sheets S can be attached to and detached from the apparatus main body 1A via the opening portion 1A1 and the space below the fixing device 80.

With the moving unit 140 moved up to the supporting position, the transfer unit 40 and the tray unit 50 can be attached to and detached from the apparatus main body 1A even if the fixing device 80 is mounted on the supporting portion 91. In other words, in a state where the fixing device 80 is positioned at the second position, the transfer unit 40 and the tray unit 50 are configured to be attached to and detached from the apparatus main body 1A via the opening portion 1A1. The transfer unit 40 and the tray unit 50 are pulled out of the apparatus main body 1A in the X direction, and attached to the apparatus main body 1A in the −X direction.

As illustrated in FIG. 4, in a state where the transfer unit 40 and the tray unit 50 are pulled out of the apparatus main body 1A, the process cartridges PY, PM, PC, and PK can be attached to and detached from the tray 51. The process cartridges PY, PM, PC, and PK can thus be replaced. The transfer unit 40 can also be replaced.

As described above, the fixing device 80, the transfer unit 40, and the tray unit 50 are configured to be attached to and detached from the side where the door 20 is disposed, of the image forming apparatus 1. Thus, the fixing device 80, the transfer unit 40, and the tray unit 50 are accessible from one side of the image forming apparatus 1 during attaching and detaching operations, which improves usability and saves the installation space required for installing the image forming apparatus 1. The cassette 31 is also configured to be attached to and detachable from the same side of the apparatus main body 1A as the opening portion 1A1, improving usability and saving space.

On the other hand, the fixing device 80 at the first position overlaps with a movement path used to attach or detach the transfer unit 40 and the tray unit 50 to or from the apparatus main body 1A. Thus, the image forming apparatus 1 can be downsized. In the present embodiment, the transfer unit 40 and the tray unit 50 can be independently attached to and detached from the apparatus main body 1A. However, the transfer unit 40 and the tray unit 50 may be configured to be integrally attached to and detached from the apparatus main body 1A.

### [Attachment and Detachment Operation of Fixing Device]

The operations of attaching and detaching the fixing device 80 will now be described with reference to FIGS. 5A to 5D. FIG. 5A is a perspective diagram illustrating the image forming apparatus 1 in a state where the door 20 is opened. FIG. 5B is a perspective diagram illustrating the fixing device 80 at the second position. FIG. 5D is a perspective diagram illustrating the image forming apparatus 1 in a state where a cover 83 is opened.

A procedure for detaching the fixing device 80 from the supporting portion 91 of the moving unit 140 will now be described. As illustrated in FIG. 5A, the user initially moves the door 20 to the opened position from the closed position. The fixing device 80 includes a fixing lock member, which engages a lock portion included in the apparatus main body 1A to hold the fixing device 80 at the first position. In other words, in a state where the fixing lock member included in the fixing device 80 engages the lock portion included in the apparatus main body 1A, upward movement of the moving unit 140 from the storage position to the supporting position is restricted. For example, in a case where jam clearance processing is performed at the conveyance path 1c or at the two-sided conveyance path 20a, the user can perform jam clearance processing in a state illustrated in FIG. 5A.

As illustrated in FIGS. 5A and 5B, regulation members 92 and lock members 93 are arranged on both the sides of the moving unit 140 in the Y direction. A release lever 96 is arranged on one side (for example, the right sight) of the moving unit 140 in the Y direction. These regulation members 92, the lock members 93, and the release lever 96 are pivotably supported by the shaft member 91b. In other words, the regulation members 92, the lock members 93, and the release lever 96 can each be pivoted relative to each other about the same shaft, i.e., the shaft member 91b.

Each of the regulation members 92 is formed in a shape that covers the respective lock member 93. An engaging hook that elastically deforms with predetermined force is arranged on a side surface of each of the lock members 93. A projection is arranged on each of the regulation members 92, and the engaging hook can pass over the projection with predetermined force. In a state where the engaging hooks engage the projections of the regulation members 92, the lock members 93 pivot integrally in tandem with the regulation members 92.

On the other hand, when the user performs a pivot operation on the lock members 93, the lock members 93 can pivot relative to the regulation members 92 while releasing the engagement between the engaging hooks of the lock members 93 and the projections of the regulation members 92. As illustrated in FIG. 2, a hook portion 93a is arranged on an end of the lock member 93, and a recess portion 84 is arranged in the fixing device 80 for the hook portion 93a to engage. When the hook portion 93a engages the recess portion 84, upward movement of the fixing device 80 is restricted. In other words, in a state where the hook portion 93a engages the recess portion 84, detachment of the fixing device 80 supported by the supporting portion 91 is restricted.

Each of the lock members 93 can be moved to a removal-regulating position where the hook portion 93a engages the recess portion 84, and a removal-allowing position where the hook portion 93a is separated from the recess portion 84. In other words, each of the lock members 93 restricts the detachment of the fixing device 80 from the supporting portion 91, and allows the detachment of the fixing device 80 from the supporting portion 91 at the removal-allowing position.

Each of the regulation members 92 is held in an upright orientation by a regulation spring. A position where each of the regulation members 92 is held in the upright orientation by the regulation spring without being affected by the external force is referred to as a home position. The lock members 93 are positioned at the removal-regulating position in a state where the engaging hooks of the lock members 93 engage the projections of the regulation members 92 positioned at the home position.

Each of the regulation members 92 positioned at the home position faces the fixing device 80 placed on the supporting portion 91 in the X direction, and prevents the fixing device 80 from falling off the supporting portion 91. More specifically, the regulation members 92 as regulation portions prevent the fixing device 80 from falling off the supporting portion 91 toward the door 20 positioned at the opened position.

As illustrated in FIG. 4, when the moving unit 140 is positioned at the supporting position, each of the regulation members 92 protrude upwards, beyond an upper surface 1g of the apparatus main body 1A. In other words, at least a part of each of the regulation members 92 is positioned above the upper surface 1g of the apparatus main body 1A when the moving unit 140 is at the supporting position. Further, at least a part of each of the regulation members 92 is positioned above an upper edge 81a of the pressure roller 81 when the moving unit 140 is at the supporting position. With the regulation members 92 so configured, the fixing device 80 can be prevented from falling off the supporting portion 91 even when a strong force is applied to the fixing device 80.

Since at least a part of the regulation members 92 protrude upward beyond the upper surface 1g of the apparatus main body 1A, the user can intuitively recognize the position where the fixing device 80 is to be attached when attaching the fixing device 80 to the supporting portion 91 as described below. This can improve attachability and detachability and usability of the fixing device 80.

The release lever 96 is configured to be pivoted in the vertical direction by the user, and the user can move the fixing lock member of the fixing device 80 by operating the release lever 96. The fixing lock member is movably supported by a frame member of the fixing device 80 at a position between the removal-regulating position and the removal-allowing position, and is urged to the removal-regulating position by an urging member.

The fixing lock member at the removal-regulating position can restrict movement of the fixing device 80 from the first position to the second position, i.e., upward movement of the moving unit 140, by engaging the lock portion of the apparatus main body 1A. The engagement between the fixing lock member and the locked portion is released at the removal-allowing position, allowing the fixing device 80 to move from the first position to the second position. The release lever 96 is operated by the user, so that the fixing lock member is moved to the removal-allowing position from the removal-regulating position.

As illustrated in FIGS. 5A and 5B, when the user opens the door 20 to the opened position from the closed position and operates the release lever 96, the fixing lock member of the fixing device 80 is moved to the removal-allowing position from the removal-regulating position, and upward movement of the moving unit 140 starts. In other words, due to the urging force of the urging member 97, the moving unit 140 is moved upward from the storage position to the supporting position, so that the fixing device 80 is moved upward from the first position to the second position.

As illustrated in FIG. 5C, the user pivots the lock members 93 from the removal-regulating position to the removal-allowing position. With this operation, the hook portions 93a of the lock members 93 are separated from the recess portions 84 of the fixing device 80, so that the fixing device 80 can be detached from the supporting portion 91.

In this state, the user can detach the fixing device 80 from the supporting portion 91 by lifting a pair of grip portions 85 arranged on the upper surface of the fixing device 80. The fixing device 80 is simply placed on the metallic frame 91a and the shaft member 91b of the supporting portion 91, and thus, the user can easily detach the fixing device 80 from the supporting portion 91 by simply lifting the fixing device 80.

When the moving unit 140 is moved up to the supporting position, the grip portions 85 are positioned above the upper surface 1g of the apparatus main body 1A. Thus, the user can easily lift the fixing device 80, so that operability can be improved.

In a state where the fixing device 80 is detached from the supporting portion 91, the supporting portion 91 can be visually observed, as illustrated in FIG. 5C. Further, the metallic frame 91a and the shaft member 91b of the supporting portion 91 extend in the Y direction over substantially the entire length of the fixing device 80, allowing the user to intuitively recognize the position where the fixing device 80 is to be mounted. In a state where the fixing device 80 is detached from the supporting portion 91, the moving unit 140 is held at the supporting position. Thus, the supporting portion 91 is positioned close to the opening portion 1A1, so that visibility of the supporting portion 91 can be improved.

When a part of the fixing device 80 reaches the end of its service life, the fixing device 80 is replaced. When a new fixing device 80 is to be attached to the supporting portion 91, the user holds the grip portions 85 with fingers and moves the fixing device 80 to the supporting portion 91 from above. At this time, if the lock members 93 are at the removal-regulating position, the lower surface of the fixing device 80 is in contact with the lock members 93.

In the present embodiment, each of the lock members 93 has a tapered surface, and lock members 93 are moved to the removal-allowing position when the tapered surfaces are pressed by the fixing device 80. Thus, the fixing device 80 can be attached to the supporting portion 91 even when the lock members 93 are at the regulation position. According to the present embodiment, the engaging hooks of the lock members 93 engage the projections of the regulation members 92, so that the lock members 93 can continuously be positioned at the removal-regulating position.

Thereafter, the user pushes the fixing device 80 or the moving unit 140 downward, moving the fixing device 80 downward until the movement of the fixing device 80 is restricted by the lock portion.

The fixing device 80 is positioned at the first position in a state where the fixing lock member arranged on the fixing device 80 engages the lock portion of the apparatus main body 1A. Thus, the user can intuitively determine to what extent the fixing device 80 should be pressed down. The user then completes the replacement of the fixing device 80 by closing the door 20.

Pressing ribs may be provided on the door 20 at positions facing the lock members 93. The pressing ribs press the lock members 93 just before the door 20 reaches the closed position.

When the door 20 reaches the closed position, the lock members 93 are pressed by the pressing ribs to be pivoted to the removal-regulating position, so that the fixing device 80 is locked by the lock members 93. Thus, the locking of the fixing device 80 to the supporting portion 91 is reliably performed, and the fixing device 80 can reliably be held at the first position while the door 20 is closed.

A case will be described where the moving unit 140 is positioned at the supporting position, and the fixing device 80 is detached from the supporting portion 91 of the moving unit 140, and the door 20 is closed to the closed position from the opened position. The regulation members 92 are pivotably supported around the shaft member 91b, and are pressed toward the discharge tray 1f by the door 20 while the door 20 is moving to the closed position from the opened position. This configuration allows the regulation members 92 to be pivoted around the shaft member 91b, preventing the regulation members 92 from being damaged. The door 20 can be moved to the closed position even in a state where the fixing device 80 is not mounted on the supporting portion 91 of the moving unit 140.

### [Jam Clearance Processing in Fixing Device]

A method of performing jam clearance on a sheet S jammed in the fixing device 80 will now be described with reference to FIGS. 5B and 5D. As illustrated in FIGS. 5B and 5D, when the sheet S nipped in the fixing nip N1 of the fixing device 80 is removed, the user moves up the fixing device 80 to the second position using the same procedure as described above for removing the fixing device 80. The user can select whether to pull the sheet S nipped in the fixing nip N1 downward or to pull the sheet S nipped in the fixing nip N1 both upward in the Z direction and horizontally in the X direction. In a case where the sheet S is pulled downward, the user pulls the sheet S downward while the fixing device 80 remains mounted on the supporting portion 91, as illustrated in FIG. 5B.

On the other hand, in a case where the sheet S is pulled in the Z and X directions, the user opens the openable and closable cover 83 disposed on the fixing device 80 as illustrated in FIG. 5D. In this manner, the user can access the vicinity of the fixing nip N1 of the fixing device 80. When the user pulls the sheet S in the Z and X directions, the force acts on the fixing device 80 via the sheet S upward in the Z direction and forward in the X direction.

However, the fixing device 80 is positioned by the regulation members 92 in the X direction, and is also positioned by the supporting portion 91 and the hook portions 93a of the lock members 93 in the Z direction. With this configuration, even when the jam clearance processing is to be performed on the sheet S nipped in the fixing device 80, the fixing device 80 is prevented from falling off the supporting portion 91 toward the door 20 positioned at the opened position by the regulation members 92 and the lock members 93. After the jam clearance processing is completed, the user closes the cover 83, moves the fixing device 80 to the first position, and closes the door 20.

As described above, closing the door 20 causes the fixing device 80 to be locked by the regulation members 92. Thus, when the jam clearance processing is to be performed on the sheet S nipped in the fixing device 80, the regulation members 92 and the fixing device 80 can be prevented from being separated. The above-described jam clearance processing can be performed when the fixing device 80 is positioned at the second position, and also at the first position. In this case, the fixing device 80 is prevented from falling off the supporting portion 91 toward the door 20 positioned at the opened position by the regulation members 92 and the lock members 93.

In the present embodiment, an upper portion of the fixing device 80 is exposed in the opening portion 1A1 and may be moved upward by the moving unit 140. The upward movement of the fixing device 80 is performed substantially in the vertical direction (the Z direction), resulting in a short travel distance as compared with a case where the fixing device 80 is moved upward by pivoting. Thus, the time required for replacement of the fixing device 80 and jam clearance processing can be reduced, which improves attachability and detachability of the fixing device 80 and jam clearance capability.

The pair of regulation members 92 is arranged on the outside of the cover 83 of the fixing device 80 in the Y direction. Thus, the regulation members 92 can be designed without considering constraints of the conveyance path of the sheet S, improving a degree of freedom in design. For example, because the regulation members 92 can be arranged close to the fixing device 80, the displacement of the fixing device 80 can be restricted. Further, in a state where the fixing device 80 is mounted on the supporting portion 91, a larger opening angle of the cover 83 can be obtained. Thus, workability can be improved when the user removes a sheet S jammed at the fixing nip N1. Furthermore, the regulation member 92 does not interfere with the sheet S to be pulled by the user, which can improve the jam clearance capability.

### [Upward Movement of Fixing Device in Case of Jam]

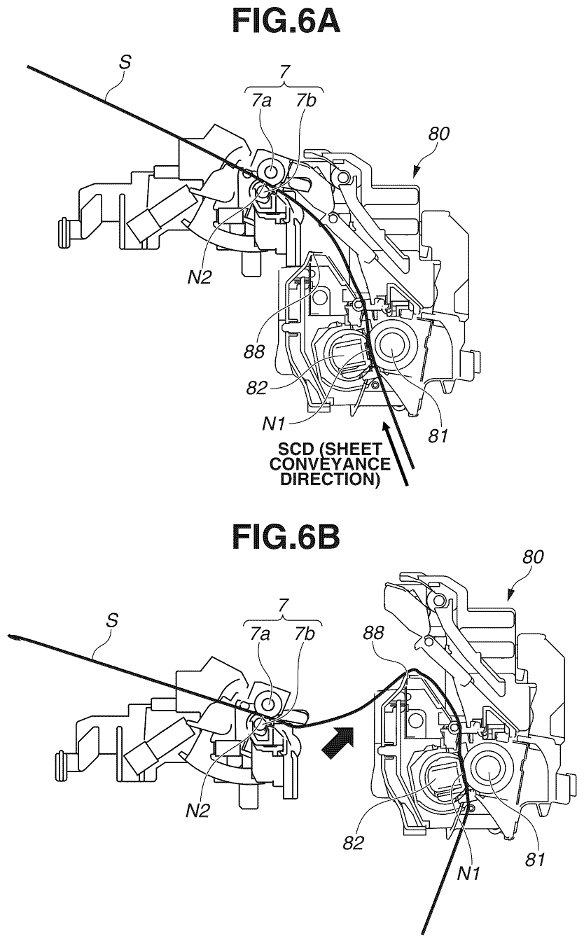

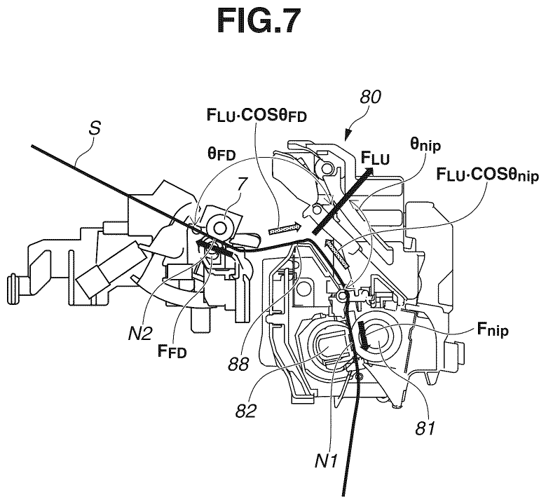

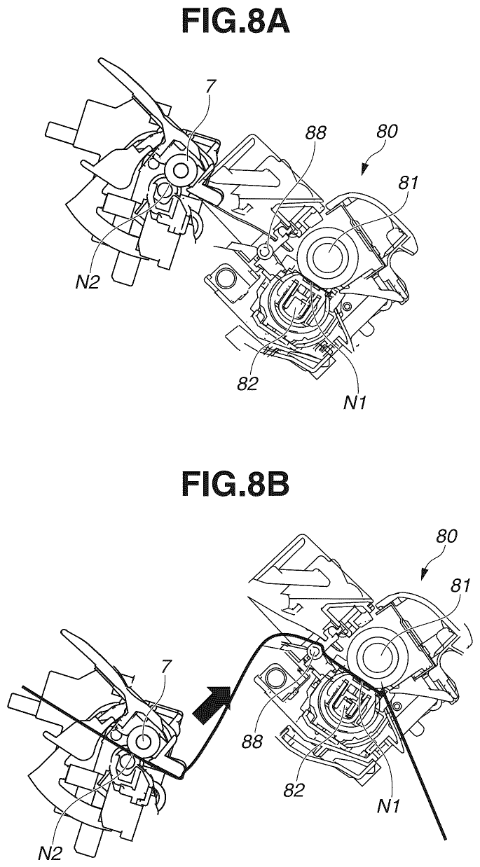

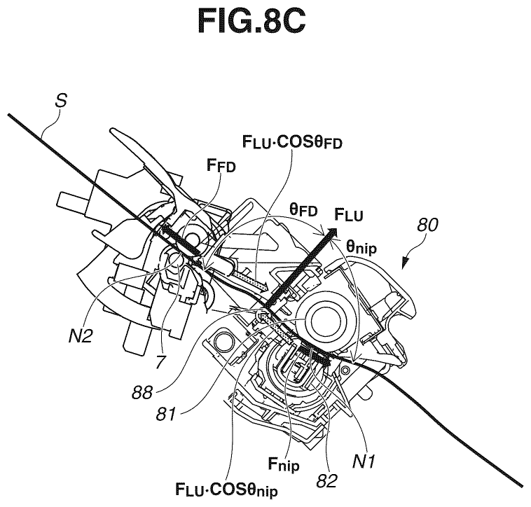

With reference to FIGS. 6A to 8C, a description is provided of upward movement of the fixing device 80 starting in a state where the sheet S is jammed while being caught in the fixing nip N1 and the discharge nip N2 formed by the pair of discharge rollers 7. FIG. 6A is a cross-sectional diagram illustrating a state where the sheet S is jammed while being caught in the fixing nip N1 and the discharge nip N2 formed by the pair of discharge rollers 7. FIG. 6B is a cross-sectional diagram illustrating a state where the fixing device 80 is moved to the second position in the state illustrated in FIG. 6A. FIG. 7 is a cross-sectional diagram illustrating forces acting on the sheet S. FIG. 8A is a cross-sectional diagram illustrating the fixing device 80 at the first position. FIG. 8B is a cross-sectional diagram illustrating a case where the fixing device 80 is moved to the second position. FIG. 8C is a cross-sectional diagram illustrating a state where upward movement of the fixing device 80 is restricted.

As illustrated in FIG. 6A, the pair of discharge rollers 7 serving as a pair of conveyance rotation members, disposed on the fixing device 80, includes a first roller 7a and a second roller 7b, and the first roller 7a and the second roller 7b form a discharge nip N2 for nipping and conveying the sheet S. Through the discharge nip N2 serving as a conveyance nip, the sheet S is discharged to the outside of the apparatus main body 1A, to be placed on the discharge tray 1f. Either the first roller 7a or the second roller 7b may be a drive roller driven by a drive motor, and the other roller may be a driven roller that is rotated following the drive roller. In the present embodiment, the first roller 7a is a drive roller, and the second roller 7b is a driven roller that is pressed against the first roller 7a with predetermined pressure force.

As illustrated in FIG. 6A, the sheet S may be jammed while being caught in the fixing nip N1 and the discharge nip N2. Thus, the pair of discharge rollers 7 is disposed to be capable of conveying the sheet S with the fixing nip N1. In this state, if the user erroneously moves the fixing device 80 upward from the first position to the second position, the fixing device 80 comes in contact with the sheet S at contact portion 88, at a position between the fixing nip N1 and the discharge nip N2. The contact portion 88 may be a part of a conveyance guide that forms a conveyance path through which the sheet S passes, or may be a driven roller rotatable in response to movement of the sheet S conveyed along the conveyance path. When the sheet S is jammed, the drive transmission to the fixing device 80 and the pair of discharge rollers 7 is stopped.

If the fixing device 80 is moved upward from the first position to the second position, the sheet S nipped in the fixing nip N1 and the discharge nip N2 becomes significantly curved, as illustrated in FIG. 6B. At this time, the sheet S is pulled at the contact portion 88 of the fixing device 80 in the direction of movement of the fixing device 80, so that the sheet S slips on at least one of the fixing nip N1 and the discharge nip N2. As described above, in a case where the sheet S is curved significantly, force required to remove the sheet S, i.e., pulling force applied to the sheet S at the time of jam clearance processing is increased, so that the jam clearance capability is degraded.

As illustrated in FIG. 7, in a case where the upward movement of the fixing device 80 starts in a state where the sheet S is jammed while being caught in the fixing nip N1 and the discharge nip N2, various forces act on the sheet S, as described herein. The fixing nip N1 applies a binding force Fₙᵢₚ to the sheet S, and stably conveys the sheet S with the binding force Fₙᵢₚ. The binding force Fₙᵢₚ of the fixing nip N1 applied to the sheet S is a product of a friction coefficient (a frictional force) μₙᵢₚ between the heating roller 82 and the pressure roller 81, and a pressure force Pip of the pressure roller 81 applied to the heating roller 82.

Similarly, the discharge nip N2 applies a binding force F_{FD} to the sheet S, and stably conveys the sheet S with the binding force F_{FD}. The binding force F_{FD} of the discharge nip N2 applied to the sheet S is the product of a friction coefficient (a frictional force) μ_{FD} between the first roller 7a and the second roller 7b, and a pressure force P_{FD} of the second roller 7b applied to the first roller 7a.

The binding force Fₙᵢₚ and the binding force F_{FD} applied to the sheet S from the fixing nip N1 and the discharge nip N2 can respectively be expressed by Equations (1) and (2):

$${F}_{nip} = {μ}_{nip} \cdot {P}_{nip} \qquad ( 1 )$$

$${F}_{FD} = {μ}_{FD} \cdot {P}_{FD} \qquad ( 2 )$$

The urging force of the urging member 97 (FIG. 3) for urging the fixing device 80 to the second position from the first position acts on the sheet S via the contact portion 88. In FIG. 7, the urging force of the urging member 97 is illustrated as urging force F_{LU}. The direction of movement of the fixing device 80 is the same as that of the urging force F_{LU}. In regions between the fixing nip N1 and the contact portion 88 and between the contact portion 88 and the discharge nip N2, tensile force derived from a component of the urging force F_{LU} of the urging member 97 acts on the sheet S. In this case, the tensile force acting on the sheet S in the region between the fixing nip N1 and the contact portion 88 is a first tensile force TF1, and the tensile force acting on the sheet S in the region between the contact portion 88 and the discharge nip N2 is a second tensile force TF2. θₙᵢₚ is an angle between the sheet S and the urging force F_{LU} in the region between the contact portion 88 and the fixing nip N1. θ_{FD} is an angle between the sheet S and the urging force F_{LU} in the region between the contact portion 88 and the discharge nip N2. Angles θₙᵢₚ and θ_{FD} are respectively expressed by Equations (3) and (4):

$$TF 1 = {F}_{LU} \cdot cos {θ}_{nip} \qquad ( 3 )$$

$$TF 2 = {F}_{LU} \cdot cos {θ}_{FD} \qquad ( 4 )$$

In a case where the first tensile force TF1 is greater than the binding force Fₙᵢₚ of the fixing nip N1 applied to the sheet S, the sheet S pulled by the fixing device 80 can be moved from the fixing nip N1 when the fixing device 80 is moved upward. In a case where the second tensile force TF2 is greater than the binding force F_{FD} of the discharge nip N2 applied to the sheet S, the sheet S pulled by the fixing device 80 can be moved from the discharge nip N2 when the fixing device 80 is moved upward. In this case, the fixing device 80 can be moved to the second position from the first position.

On the other hand, in a case where the first tensile force TF1 is less than the binding force Fₙᵢₚ of the fixing nip N1 applied to the sheet S, and the second tensile force TF2 is also less than the binding force F_{FD} of the discharge nip N2 applied to the sheet S, the sheet S is held by the fixing nip N1 and the discharge nip N2. Thus, upward movement of the fixing device 80, i.e., movement of the fixing device 80 from the first position to the second position, is restricted.

In order to fix a melted unfixed toner image to a sheet by applying pressure to the toner image, a pressure force of approximately 10 [N/m2] or more is generally set as the pressure force of the pressure roller 81 applied to the heating roller 82. On the other hand, in terms of the jam clearance capability for the sheet S nipped in the fixing nip N1 and the discharge nip N2, it is desirable to set the binding force (the nipping pressure) applied to the sheet S at the fixing nip N1 and the discharge nip N2 to be as small as possible. In order to upwardly move the fixing device 80, the urging force F_{LU} of the urging member 97 needs to be set to a predetermined value or more.

In the present embodiment, the urging force F_{LU} of the urging member 97, the binding force Fₙᵢₚ of the fixing nip N1 applied to the sheet S, and the binding force F_{FD} of the discharge nip N2 applied to the sheet S are set to satisfy Equations (5) and (6):

$$TF 1 = ( {F}_{LU} \cdot cos {θ}_{nip} ) < {F}_{nip} \qquad ( 5 )$$

$$TF 2 = ( {F}_{LU} \cdot cos {θ}_{FD} ) < {F}_{FD} \qquad ( 6 )$$

The contact portion 88 of the fixing device 80 is in contact with the sheet S in a region between the fixing nip N1 and the discharge nip N2, and thus, the first tensile force TF1 and the second tensile force TF2 based on components of the urging force F_{LU} of the urging member 97 act in the opposite directions to each other along the sheet S. The first tensile force TF1 and the binding force Fₙᵢₚ act in the opposite directions to each other along the sheet S, and the second tensile force TF2 and the binding force F_{FD} act in the opposite directions to each other along the sheet S. Thus, if Equations (5) and (6) above are satisfied, upward movement of the fixing device 80 is restricted by the sheet S which is jammed while being caught in the fixing nip N1 and the discharge nip N2.

As illustrated in FIG. 8A, a conveyance path between the fixing device 80 positioned at the first position and the pair of discharge rollers 7 is configured to be relatively linear. Further, a pair of rollers for nipping and conveying the sheet S is not disposed between the fixing nip N1 and the discharge nip N2 in a sheet conveyance direction SCD (FIG. 6A). If the fixing device 80 is moved to the second position in a state where the sheet S is jammed while being caught in the fixing nip N1 and the discharge nip N2 as illustrated in FIG. 8B, jam clearance processing cannot be performed easily.

In the above-described configuration, in a case where upward movement of the fixing device 80 starts in a state where the sheet S is jammed while being caught in the fixing nip N1 and the discharge nip N2, various types of force act on the sheet S, as illustrated in FIG. 8C. By starting the upward movement of the fixing device 80, the contact portion 88 of the fixing device 80 comes in contact with the sheet S. In this case, the forces acting on the sheet S are similar to those illustrated in FIG. 7.

At this time, even if the user erroneously moves up the fixing device 80 in a state where the sheet S is jammed while being caught in the fixing nip N1 and the discharge nip N2, the upward movement is restricted since the present embodiment satisfies Equations (5) and (6) above. Thus, the sheet S is prevented from being curved as illustrated in FIG. 8B, so that degradation of the jam clearance capability can be prevented.

### Second Embodiment

A second embodiment of the present disclosure will now be described. In the present embodiment, a division member 8 is disposed on the fixing device 80, which is provided as described in the first embodiment. Thus, constituent elements similar to those of the first embodiment are not illustrated, or are assigned the same reference numerals as those in the first embodiment and description thereof is incorporated herein by reference.

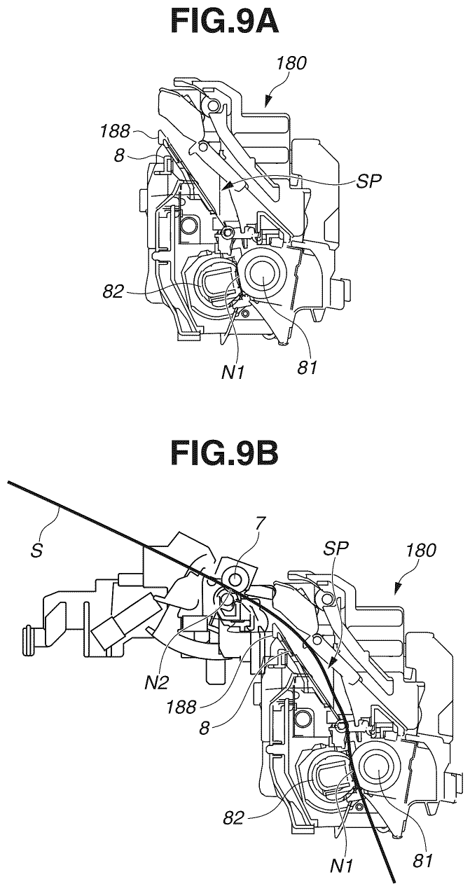

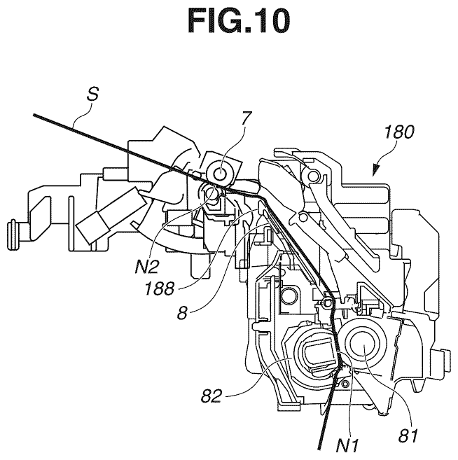

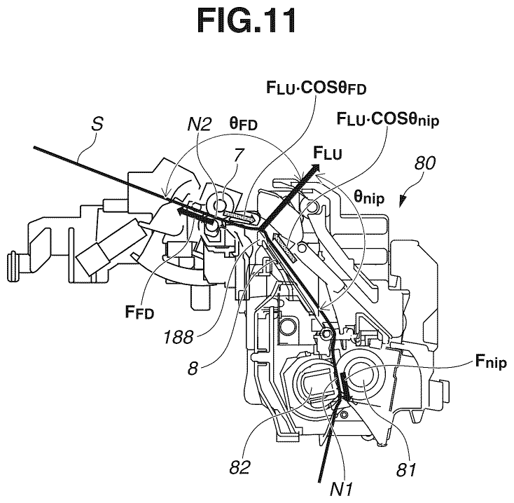

FIG. 9A is a cross-sectional diagram illustrating a fixing device 180 according to the present embodiment. FIG. 9B is a cross-sectional diagram illustrating a state where the sheet S is jammed while being caught in the fixing nip N1 and the discharge nip N2 formed by the pair of discharge rollers 7. FIG. 10 is a cross-sectional diagram illustrating a state where an end portion 188 of the division member 8 is in contact with the sheet S. FIG. 11 is a cross-sectional diagram illustrating forces acting on the sheet S.

As illustrated in FIG. 9A, the fixing device 180 according to the present embodiment includes the division member 8. The division member 8 divides a conveyance space SP where the sheet S that has passed through the fixing nip N1 passes and the outside of the fixing device 180 (i.e., the exit of the conveyance space SP) at the exit position of the conveyance space SP in the sheet conveyance direction. As illustrated in FIG. 9B, when the fixing device 180 is at the first position, the division member 8 is positioned below the conveyance space SP where the division member 8 does not interfere with the conveyance of the sheet S. The division member 8 extends along the conveyance space SP, and has the end portion 188 closer to the discharge nip N2 than the fixing nip N1. The end portion 188 serving as a contact portion is arranged in the vicinity of the discharge nip N2 when the fixing device 180 is positioned at the first position.

In the above-described configuration, in a case where the upward movement of the fixing device 180 starts in a state where the sheet S is jammed while being caught in the fixing nip N1 and the discharge nip N2, various forces act on the sheet S, as illustrated in FIG. 11. By starting the upward movement of the fixing device 180, the end portion 188 of the division member 8 comes in contact with the sheet S. At this time, the forces acting on the sheet S are similar to those illustrated in FIG. 7. In other words, in a region between the fixing nip N1 and the leading end portion 188, the first tensile force TF1 derived from a component of the urging force F_{LU} of the urging member 97 acts on the sheet S. Further, in a region between the end portion 188 and the discharge nip N2, the second tensile force TF2 derived from a component of the urging force F_{LU} of the urging member 97 acts on the sheet S.

At this time, even if the user erroneously upwardly moves the fixing device 180 in a state where the sheet S is jammed while being caught in the fixing nip N1 and the discharge nip N2, the upward movement is restricted since the present embodiment satisfies Equations (5) and (6), described in the above first embodiment. Thus, the sheet S is prevented from being significantly curved, so that degradation of the jam clearance capability can be prevented.

According to the present embodiment, the end portion 188 of the division member 8 which is in contact with the sheet S is arranged in the vicinity of the discharge nip N2. Thus, the upward movement of the fixing device 180 is restricted immediately after the fixing device 180 starts to move upward. This is because a contact point of the sheet S that is in contact with the end portion 188 has a small distance over which the contact point of the sheet S can move in the direction of the urging force F_{LU}. Thus, as compared with the case in the first embodiment, the upward movement of the fixing device 180 can be restricted quickly, so that degradation of the jam clearance capability can be prevented. By changing the arrangement of the division member 8, a degree of freedom in the direction of upward movement of the fixing device 180 can be improved.

### OTHER EMBODIMENTS

In the above-described embodiments, the configuration has been described by taking the sheet S which is jammed while being caught in the fixing nip N1 and the discharge nip N2 as an example. However, the configuration is not limited thereto. For example, a pair of conveyance rollers having a conveyance nip may be disposed between the fixing nip N1 and the discharge nip N2.

In this case, the above-described discharge nip N2 can be regarded as the conveyance nip, and it is sufficient that the above Equations (5) and (6) are satisfied.

In any of the above-described embodiments, the fixing devices 80 and 180 are urged toward the second position from the first position by a single urging member 97 disposed on the moving unit 140. However, the configuration is not limited thereto. For example, a plurality of urging members 97 may be disposed on the moving unit 140.

In any of the above-described embodiments, the pair of regulation members 92 is disposed on the moving unit 140. However, the configuration is not limited thereto. For example, a single regulation member or three or more regulation members may be disposed on the moving unit 140.

In any of the above-described embodiments, the pair of lock members 93 is disposed on the moving unit 140. However, the configuration is not limited thereto. For example, a single lock member or three or more lock members may be disposed on the moving unit 140.

In any of the above-described embodiments, the fixing device 80, 180 is prevented from falling off the supporting portion 91 by the regulation members 92 and the lock members 93. However, the configuration is not limited thereto. For example, the lock members 93 may not be included, and instead, the fixing device 80, 180 may be prevented from falling off the supporting portion 91 by the regulation members 92. Alternatively, the regulation members 92 may not be included, and instead, the fixing device 80, 180 may be prevented from falling off the supporting portion 91 by the lock member 93.

In the above-described embodiments, the regulation members 92 and the lock members 93 are pivotably supported by the same shaft member 91b. However, the configuration is not limited thereto. For example, the lock members 93 may be pivotably supported by the regulation members 92.

In any of the above-described embodiments, the second position of the fixing device 80, 180 is positioned above the first position. However, the configuration is not limited thereto. For example, the fixing device 80, 180 may be moved from the first position to the second position in the horizontal direction or obliquely downward.

In any of the above-described embodiments, the lifting portion 100 includes a link mechanism including a plurality of arms. However, the configuration is not limited thereto. For example, the lifting portion 100 may include a rack portion which is configured to engage a pinion gear disposed on the supporting portion 91 to lift the supporting member 91. With the pinion gear disposed on the supporting portion 91, the rack member may be disposed on the lifting portion 100. As described above, the configuration of the lifting portion 100 is not limited.

In any of the above-described embodiments, while the fixing device 80, 180 includes the heating roller 82 and the pressure roller 81, the configuration is not limited thereto. For example, a heating unit including a heater, such as a ceramic heater, and a fixing film heated by the heater may be used instead of the heating roller 82. Alternatively, a fixing belt having a heat generation layer that generate heat by induction heating may be employed instead of the heating roller 82.

In any of the above-described embodiments, the photosensitive drum 62, the charging roller 61, and the development roller 63 are disposed in each of the process cartridges PY to PK. However, the configuration is not limited thereto. In other words, it is sufficient that the photosensitive drum 62, the charging roller 61, and the development roller 63 are disposed in either the process cartridge or the tray 51.

In the above-described embodiments, the door 20 is pivotably disposed around the pivot shaft 20b. However, the configuration is not limited thereto. For example, a slidable cover or a removable cover with respect to the apparatus main body 1A may be disposed instead of the door 20.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-169370, filed Sep. 27, 2024, which is hereby incorporated by reference herein in its entirety.

What is claimed is:

1. An image forming apparatus that forms a toner image on a sheet, the image forming apparatus comprising:
an apparatus main body having an opening portion;
an opening and closing member, wherein in a closed position the opening and closing member covers the opening portion, and in an opened position the opening and closing member uncovers the opening portion;
a fixing unit detachable from and supported by the apparatus main body via the opening portion, the fixing unit including a heating unit configured to heat the toner image formed on the sheet and a pressure roller, wherein a fixing nip for nipping the sheet is formed by the pressure roller and the heating unit;
a pair of conveyance rotation members configured to form a conveyance nip for nipping and conveying the sheet, with the pair of conveyance rotation members being arranged to convey the sheet with the fixing nip, and with the pair of conveyance rotation members being arranged on the apparatus main body downstream of the fixing unit in a sheet conveyance direction; and
a moving unit arranged on the apparatus main body, configured to move the fixing unit from a first position to a second position, wherein the moving unit includes an urging portion configured to provide a force urging the fixing unit toward the second position from the first position,
wherein, with the opening and closing member in the closed position, movement of the fixing unit from the first position to the second position is restricted, and
wherein, with the opening and closing member in the opened position, movement of the fixing unit by the moving unit is allowed.

2. The image forming apparatus according to claim 1, wherein:
the fixing unit includes a contact portion configured to contact the sheet at a position between the fixing nip and the conveyance nip,
in a case where the sheet is jammed in at least one of the fixing nip and the conveyance nip, the contact portion contacts the sheet in response to moving the fixing unit from the first position to the second position, and
in a case where the urging portion acts on the jammed sheet, the urging portion is configured to apply, as a component of the urging force, a tensile force on the sheet between the fixing nip and the contact portion.

3. The image forming apparatus according to claim 2, wherein:
the tensile force is less than a binding force of the fixing nip applied to the sheet and
the tensile force acting on the sheet between the conveyance nip and the contact portion is less than a binding force of the conveyance nip applied to the sheet.

4. The image forming apparatus according to claim 3, wherein:
$${F}_{LU} \cdot cos {θ}_{nip} < {F}_{nip}$$
$${F}_{LU} \cdot cos {θ}_{FD} < {F}_{FD} ,$$
where F_{LU} is the urging force, Fₙᵢₚ is the binding force of the fixing nip applied to the sheet, F_{FD} is the binding force of the conveyance nip applied to the sheet, θₙᵢₚ is an angle between the urging force and the sheet positioned between the contact portion and the fixing nip, and θ_{FD} is an angle between the urging force and the sheet positioned between the contact portion and the conveyance nip.

5. The image forming apparatus according to claim 1,
wherein the fixing unit includes a division member configured to divide a conveyance space for the sheet to pass through the fixing nip to an outer portion of the fixing unit at an exit of the conveyance space in the sheet conveyance direction.

6. The image forming apparatus according to claim 5, wherein, with the fixing device in the first position, the division member is positioned below the conveyance space and the division member does not interfere with the conveyance of the sheet.

7. The image forming apparatus according to claim 5,
wherein the contact portion is an end portion of the division member closer to the conveyance nip than the fixing nip.

8. The image forming apparatus according to claim 1, wherein the pair of conveyance rotation members is a pair of discharge rollers configured to discharge a sheet to which a toner image is fixed by the fixing unit to an outside of the apparatus main body.

9. The image forming apparatus according to claim 1,
wherein, with the fixing unit positioned at the first position, the fixing unit does not overlap with the opening and closing member positioned at the closed position when viewed in a lengthwise direction of the fixing unit, and
wherein, with the fixing unit positioned at the second position, the fixing unit at least partly overlaps with the opening and closing member positioned at the closed position when viewed in the lengthwise direction of the fixing unit.

10. The image forming apparatus according to claim 1, wherein the second position is vertically above the first position.

11. The image forming apparatus according to claim 1, wherein:
the moving unit includes a supporting portion and a regulation portion,
the supporting portion is configured to support the fixing unit positioned at the second position in a detachable manner, and
the regulation portion is configured to prevent the fixing unit from falling off the supporting portion.

12. The image forming apparatus according to claim 11, wherein the regulation portion is pivotably supported by the supporting portion.

13. The image forming apparatus according to claim 11, wherein:
the moving unit is configured to move between a storage position and a supporting position,
in the storage position, the opening and closing member is positioned at the closed position, and
in the supporting position, the moving unit is configured to support the fixing unit positioned at the second position.

14. The image forming apparatus according to claim 11, wherein at least a part of the regulation portion is positioned above an upper edge of the pressure roller when the moving unit is positioned at the supporting position.

15. The image forming apparatus according to claim 1, wherein a pair of rollers for nipping and conveying a sheet is not disposed between the fixing nip and the conveyance nip in the sheet conveyance direction.

16. The image forming apparatus according to claim 1, further comprising an image forming unit for forming the toner image on the sheet,
wherein, in a state where the fixing unit is moved to the second position by the moving unit, the image forming unit is configured to be attachable to and detachable from the apparatus main body via the opening portion.
